(19) United States
(12) Patent Application Publication
(10) Pub. No.: US 2014/0015643 A1
(43) Pub. Date: Jan. 16, 2014

(54) THERMALLY-ARMORED RADIO-FREQUENCY IDENTIFICATION DEVICE AND METHOD OF PRODUCING SAME

(71) Applicant: Richard S. Shankman, Boca Raton, FL (US)

(72) Inventor: Richard S. Shankman, Boca Raton, FL (US)

(73) Assignee: AITA, LLC, Boca Raton, FL (US)

(21) Appl. No.: 14/005,900

(22) PCT Filed: Mar. 19, 2012
(86) PCT No.: PCT/US12/29693

§ 371 Date: Oct. 2, 2013

Related U.S. Application Data
(60) Provisional application No. 61/454,159, filed on Mar. 18, 2011.

(51) Int. Cl. G06K 19/07

(52) U.S. Cl. CPC G06K 19/0723
USPC 340/10.1; 29/600; 235/492

(57) ABSTRACT

A thermally-armored RFID tag is configured to withstand extreme temperatures associated with certain product fabrication, including, but not limited to, the temperatures of molten metal and plastic. The thermal protection allows the RFID tag to be inserted into products during their fabrication, molding, casting, or extrusion, instead of being applied to the surface or inserted into the surface of the products after their fabrication

### REFERENCE TO RELATED APPLICATIONS

This application claims the benefit of U.S. Provisional Patent Application Number 61/454,159, filed Mar. 18, 2011 and titled Thermally-Armored Radio-Frequency Identification Device and Method of Producing Same, the contents of which are incorporated herein by reference in their entirety.

### BACKGROUND OF THE INVENTION

1. Field of the Invention

The invention pertains to the field of radio-frequency identification (RFID) technology. More particularly, the invention pertains to methods and devices for thermally-resistant RFID devices and methods of making same.

2. Description of Related Art

An RFID system conventionally includes two fundamental parts, namely a “reader” (also known as an “interrogator”) or radio signal receiver and a transmitting “tag” or RFID tag. Radio wave communication data exchange between the tag and the reader permits the unique identification of the tag and hence the unique identification of an item associated with the tag, generally for the purpose of tracking, identifying, or establishing the authenticity of the item. The computer software utilized to decode the radio signal's pertinent information is generally referred to as “middleware”. The modern field of RFID includes a number of different sub-arts, including low-frequency identification (LowFID, generally 125-134.2 kHz and 140-148.5 kHz), high-frequency identification (HighFID, generally 13.56 MHz), ultra-high frequency identification (UHFID or Ultra-HighFID, generally 868-928 MHz), fixed or stationary RFID, mobile RFID, passive RFID, and active RFID.

RFID tags may be passive with no power source, battery-assisted passive (BAP), or active with an on-board battery allowing constant transmission of a radio signal depending on the desired sophistication and application for the RFID tag.

U.S. Pat. No. 3,713,148, entitled “Transponder Apparatus and System” and issued to Cardullo et al. on Jan. 23, 1973, is a landmark patent covering RFID technology. The patent teaches that a transponder apparatus can communicate with a remote transponder via an “interrogation” radio signal, causing a reaction (“answerback”) radio transmission from the remote transponder device. The decoder and logic in the receiver can interpret the radio “answerback” signal to identify the remote device and read data from its internal memory.

U.S. Pat. No. 4,384,288, entitled “Portable Radio Frequency Emitting Identifier” and issued to Walton on May 17, 1983, was the first patent to use the now-standard acronym “RFID”.

U.S. Pat. No. 5,973,599, entitled “High Temperature RFID Tag” and issued to Nicholson et al. on Oct. 26, 1999, and U.S. Pat. No. 6,255,949, entitled “High Temperature RFID Tag” and issued to Nicholson et al. on Jul. 3, 2001, disclose high temperature RFID tags with a survival temperature range of −40° C. to 300° C. and an operating temperature range of −20° C. to 200° C. The RFID tag includes a housing with a thermally resistant material and a base and a top, and a circuit board substrate including a thermally resistant material which is encapsulated within the housing. The RFID tag is designed for cyclical high temperature exposures.

U.S. Pat. No. 7,636,046, entitled “Wireless Tracking System and Method with Extreme Temperature Resistant Tag” and issued to Caliri et al. on Dec. 22, 2009, discloses a wireless tracking system and method for real-time location-tracking of an extreme-temperature sterilizable object. The system and method use an RFID tag attached to the sterilizable object which includes a housing, a processor, a temperature sensor, and a transceiver. If a critical internal temperature of the tag is detected by the temperature sensor, the tag enters an inactive “sleep mode”. The temperature sensor periodically activates to determine if the internal temperature of the tag is within an acceptable operating range, thereafter reactivating it. The RFID tag is operable up to temperatures of 120° F.

U.S. Pat. App. Pub. No. 2010/0259393, entitled “Encapsulated RFID Tags and Methods of Making Same” by Marur et al. and published Oct. 14, 2010, discloses encapsulated RFID articles with enhanced break strength or temperature resistance and methods of making these articles. The RFID articles include an RFID tag embedded within a thermoplastic substrate to form the RFID article. In one embodiment, the RFID article includes an over-molded barrier material that enables the RFID article to have enhanced temperature resistance, such that the articles are able to sustain repeated exposure to high temperatures or sterilization procedures. In other embodiments, the RFID articles are made using an injection molding process that provides very thin encapsulated RFID tags that also exhibit an increased level of temperature resistance, but the actual operability temperatures are not disclosed.

U.S. Pat. App. Pub. No. 2011/0017832, entitled “RFID Tag” by Ritamaki et al. and published Jan. 27, 2011, discloses an RFID tag including a heat-resistant substrate made of a plastic film and capable of withstanding temperatures up to 200° C., an antenna formed on the surface of the substrate, an integrated circuit on a silicon chip electrically connected to the antenna, and a joint for attaching the chip to the substrate so that the chip is capable of connecting electrically to the antenna. The joint is made of an isotropically conductive adhesive capable of withstanding temperatures up to 200° C. with a thermal expansion coefficient similar to that of the silicon chip.

Technologies ROI, LLC (Simpsonville, S.C., United States) advertises an armored RFID tag (see Swedberg, “Armored-RFID Tag Loves to Get Hammered”, RFID Journal, Jun. 29, 2010) that is housed in a ⅛-inch thick steel shell. The tag can withstand temperatures up to 600° F. (316° C.) and read at a distance of up to two meters. The armoring, however, is primarily for physical protection of the RFID tag rather than thermal protection and the large size of the armored RFID tag restricts its uses.

With the use of individual and exclusive “identifiers” in the “answerback” radio signal from RFID tags, it is possible to track the identity and movements of each and every product in an assembly line, grocery store, hospital, retail store, commuting automobile using a toll road, etc. In the case of “passive” RFID devices, those without a battery for a power source, it is possible to track and identify items that can be made to pass in close proximity to an interrogating radio device. Further, these passive RFID devices may be concealed within or on the surface of products or their external packaging, thereby leaving them largely undetected.

The use of RFID for vehicle identification is known in the art. For example, e-plate (www.e-plate.com) offers active RFID tags for Electronic Vehicle Identification (EVI). These tags, however, are at best affixed to a surface of the vehicle and therefore are subject to removal or tampering after theft and do not provide sufficient theft deterrence.

Much effort has been devoted to reducing the unit cost of RFID tags. Currently, a passive RFID tag for general retail merchandise costs roughly US $0.05, and the cost increases to around US $5 for a tag designed to withstand gamma ray sterilization. Larger active RFID modules for tracking shipping containers or larger more valuable electronic devices can cost in excess of US $100. Environmentally-rugged RFID tags command a premium in the market.

All above-mentioned references are hereby incorporated herein by reference in their entirety.

### SUMMARY OF THE INVENTION

In one embodiment, a method comprises inserting an RFID tag, which may be either passive, battery-assisted passive, or active, within the material of an item or product, thereby concealing it permanently within such item or product and greatly increasing the ability to conceal it from detection or efforts at tampering with or deactivating it.

In one embodiment, the thermally-armored RFID tag is designed to withstand enormous heat conditions and certain high-heat conditions found in the molding of plastics, the fabrication of metal products, and any other product fabrication processes involving temperatures that would normally make RFID tag insertion impossible without destruction of the device due to ambient heat. Such insertion of currently-available RFID tags during the high-heat stages of certain product fabrication is not impossible using the method and materials of the invention. In one embodiment, the thermally-armored RFID tag is an improvement over some of the above-described art in that the functional parts of the tag are truly shielded from high or low temperatures by the coating rather than the functional parts being modified to be able to withstand traditionally damaging temperature extremes. This advancement keeps RFID tag costs at a minimum, as the existing RFID tag technologies may be employed with the addition of the novel thermal armor shielding.

In one embodiment, the thermal-armor coating comprises a modified polyphenylene ether (PPE)/olefin resin blend, a vinyl ester resin, a reinforced carbon-carbon (RCC) resin, a phenolic resin, a ceramic enamel, a glass enamel, a vermiculite enamel, a silicate-based fiber or cloth resin-impregnated enamel, a flame-resistant meta-aramid material-based fiber or cloth resin-impregnated enamel, a silicon-based resin, silica glass fibers, and multi-layer or multi-component composite coatings comprising any combination of the aforementioned.

In one embodiment, the thermally-armored RFID tag and method of production make possible the permanent and relatively-undetectable insertion of an RFID tag into a product during creation of the product, regardless of the heat or cold conditions inherent in the product's formation, fabrication, or molding process. The RFID device is thermally armored in such a manner as to protect the internal integrated circuit, antenna, and any other apparatus within the device's shell and located beneath the thermal armor, from the destructive force of excessive heat or cold.

In one embodiment, the thermally-armored RFID tag is inserted into a molten or semi-molten material at an elevated temperature prior to cooling of the material to a solid or semi-solid state. In one embodiment, the thermally-armored RFID tag is inserted into a molten plastic prior to cooling of the molten plastic to a solid state. In one embodiment, the thermally-armored RFID tag is inserted into a molten polymer prior to cooling of the polymer to a solid state. In one embodiment, the thermally-armored RFID tag is inserted into a molten composite material prior to cooling of the composite material to a solid state. In one embodiment, the thermally-armored RFID tag is inserted into a molten metal prior to cooling of the metal to a solid state.

The outer protective thermal armor may be any thermally-protective coating, now known or later developed, sufficient to protect the RFID tag from thermal damage.

### BRIEF DESCRIPTION OF THE DRAWINGS

The invention will be described with reference to the accompanying drawing.

FIG. 1 depicts a cross-sectional representation of a thermally-armored RFID tag according to one embodiment of the invention.

### DETAILED DESCRIPTION OF THE INVENTION

In one embodiment, a method comprises inserting an RFID tag, which may be either passive, battery-assisted passive, or active, within the material of an item or product, thereby concealing it permanently within such item or product and greatly increasing the ability to conceal it from detection or efforts at tampering with or deactivating it.

In one embodiment, the thermally-armored RFID tag is designed to withstand enormous heat conditions and certain high-heat conditions found in the molding of plastics, the fabrication of metal products, and any other product fabrication processes involving temperatures that would normally make RFID tag insertion impossible without destruction of the device due to ambient heat. Such insertion of currently-available RFID tags during the high-heat stages of certain product fabrication is not impossible using the method and materials of the invention. In one embodiment, the thermally-armored RFID tag is an improvement over some of the above-described art in that the functional parts of the tag are truly shielded from high or low temperatures by the coating rather than the functional parts being modified to be able to withstand traditionally damaging temperature extremes. This advancement keeps RFID tag costs at a minimum, as the existing RFID tag technologies may be employed with the addition of the novel thermal armor shielding.

In one embodiment, the thermally-armored RFID tag and method of production make possible the permanent and relatively-undetectable insertion of an RFID tag into a product during creation of the product, regardless of the heat or cold conditions inherent in the product's formation, fabrication, or molding process. The RFID device is thermally armored in such a manner as to protect the internal integrated circuit, antenna, and any other apparatus within the device's shell and located beneath the thermal armor, from the destructive force of excessive heat or cold.

In one embodiment, the thermally-armored RFID tag is a low-frequency tag. LowFID tags are less affected by shielding than HighFID and UHFID tags and insertion into a high-shielding material well below the surface of the material does not affect operation of the thermally-armored LowFID tag as much as it might a HighFID and UHFID tag. In one embodiment, the thermally-armored RFID tag is designed to be operable through a high-shielding material such as a metal. In one embodiment, the thermally-armored RFID tag comprises a specially-designed antenna such that the thermally-armored RFID tag is operable through a high-shielding material such as a metal. In embodiments where the tag is to be inserted near the surface of the material or the material has a low-shielding value, thermally-armored HighFID or UHFID tags may be used.

In one embodiment, the thermally-armored RFID tag is inserted into a molten or semi-molten material at an elevated temperature prior to cooling of the material to a solid or semi-solid state. In one embodiment, the thermally-armored RFID tag is inserted into a molten plastic prior to cooling of the molten plastic to a solid state. In one embodiment, the thermally-armored RFID tag is inserted into a molten polymer prior to cooling of the polymer to a solid state. In one embodiment, the thermally-armored RFID tag is inserted into a molten composite material prior to cooling of the composite material to a solid state. In one embodiment, the thermally-armored RFID tag is inserted into a molten metal prior to cooling of the metal to a solid state.

The outer protective thermal armor may be any thermally-protective coating sufficient to protect the RFID tag from thermal damage, including, but not limited to:

(1) a modified polyphenylene ether (PPE)/olefin resin blend, including, but not limited to:
(a) a Noryl® resin (GE Advanced Materials, Wilton, Conn., United States),
(b) a polyphenylene oxide (PPO)/polystyrene (PS) alloy resin, including, but not limited to, a Noryl® PKN resin (GE Advanced Materials, Wilton, Conn., United States), and
(c) a polyphenylene ether (PPO)/polypropylene (PP) alloy resin, including, but not limited to, a Noryl® PPX 615 alloy of polyphenylene ether (PPE) and polypropylene (PP) resin (GE Advanced Materials, Wilton, Conn., United States),

(2) a vinyl ester resin, including but not limited to, aromatic ethers and oligoethers with vinyl aromatic and methacrylate end groups capable of crosslinking and polycyclization, including, but not limited to:
(a) a Rolivsan (RR) (Russian Academy of Sciences, Moscow, Russia) resin, and
(b) a Zaitform (ZR) (Russian Academy of Sciences, Moscow, Russia) resin,

(3) a reinforced carbon-carbon (RCC) resin, including, but not limited to, a composite material of carbon fiber reinforcement in a graphite matrix,

(4) a phenolic resin,

(5) a ceramic enamel,

(6) a glass enamel,

(7) a vermiculite enamel,

(8) a silicate-based fiber or cloth resin-impregnated enamel, including, but not limited to, an asbestos-based fiber or cloth resin-impregnated enamel,

(9) a flame-resistant meta-aramid material-based fiber or cloth resin-impregnated enamel, including, but not limited to, a Nomex® (E.I. du Pont de Nemours and Co., Wilmington, Del., United States)-based fiber or cloth resin-impregnated enamel,

(10) a silicon-based resin, including, but not limited to, a silicon carbide epoxy resin, including, but not limited to:
(a) a silicon carbide epoxy resin densified with tetraethyl orthosilicate (TEOS), and
(b) an amorphous silica fiber resin with a colloidal silica binder, which may be sintered into the outer metal casing of the RFID tag,

(11) silica glass fibers, including, but not limited to, LI-900 (Lockheed Missiles and Space Company, Sunnyvale, Calif., United States), a matrix of 99.9% pure silica glass fibers with 94% by volume air for an overall density of 9 lb/ft³, which is used on Space Shuttle thermal tiles,

(12) a multi-layer or multi-component composite coating comprising any combination of the above-mentioned coatings.

The material used for and the thickness of the thermal coating of the thermally-armored RFID tag are typically selected based on the maximum temperature to which the RFID tag is to be exposed. In one embodiment, the thermally-coated RFID tag comprises any thermally-protective coating, now known or later developed, sufficient to protect the RFID tag from thermal damage. In one embodiment, the thermal coating completely encapsulates the thermally-armored RFID tag. A person of ordinary skill in the art can coat the RFID tag according to the invention without undue experimentation.

In one embodiment, such as when the item to be tagged with the thermally-armored RFID tag is a polymeric material, the thermal coating is effective to protect the thermally-armored RFID tag up to temperatures of at least 200° C. (392° F.). In one embodiment, such as when the item to be tagged with the thermally-armored RFID tag is a polymeric material, the thermal coating is effective to protect the thermally-armored RFID tag up to temperatures of at least 300° C. (572° F.). In one embodiment, such as when the item to be tagged with the thermally-armored RFID tag is a silver item, the thermal coating is effective to protect the thermally-armored RFID tag up to temperatures of at least 900° C. (1,652° F.). In one embodiment, such as when the item to be tagged with the thermally-armored RFID tag is a pure silver item, the thermal coating is effective to protect the thermally-armored RFID tag up to temperatures of at least 1,000° C. (1,832° F.). In one embodiment, such as when the item to be tagged with the thermally-armored RFID tag is a gold item, the thermal coating is effective to protect the thermally-armored RFID tag up to temperatures of at least 1,100° C. (2,012° F.). In one embodiment, the thermal coating is effective to protect the thermally-armored RFID tag up to temperatures of at least 1,200° C. (2,200° F.). In one embodiment, the thermal coating is effective to protect the thermally-armored RFID tag up to temperatures of at least 1,660° C. (3,020° F.).

In one embodiment, the thermal coating on the thermally-armored RFID tag is akin to a thermal coating used on Space Shuttle tiles used to protect the Shuttle from heat upon re-entry into the earth's atmosphere and the cold of outer space.

In one embodiment, the thermally-armored RFID tag comprises a very small RFID tag, such as those manufactured by Hitachi, Ltd. (Hitachi RFID Solutions, System Solutions Div., of Hitachi Europe Ltd., Maidenhead, UK), which can be made with an area as small as 0.05 square mm. These RFID tags can nonetheless utilize a 128-bit read-only-memory (ROM) and store 38 digit serial numbers. In one embodiment, the dust-sized RFID tag is completely encapsulated in the thermally-insulating material as described herein to withstand the heat extremes of molten metal or plastic present during product fabrication, at which time the thermally-armored RFID tag is inserted into the product, while still remaining relatively small in size.

In one embodiment, the encapsulated RFID tag is not itself thermally-resistant; instead, the thermal coating provides thermal resistance such that the RFID tag itself does not reach the high or low temperatures that would damage or destroy the tag. The RFID tag to be encapsulated may be of any size, shape, or design known in the art. In one embodiment, the tag comprises a small surface area to minimize the amount of thermal coating required. In one embodiment, the RFID tag itself is surrounded by a non-thermally resistant material, which is compatible with and conducive to the bonding of a thermal coating, which is applied to the non-thermally resistant material.

In one embodiment, the article of manufacture includes a thermally-armored RFID tag contained in and visually concealed by the material of the article of manufacture. The article of manufacture may be any article having a fabricated, molded, cast, or extruded component, including, but not limited to, a precious metal bar or round, a piece of furniture, electronic equipment, or a vehicle.

In one embodiment, the thermally-armored RFID tag is part of an identification system for a particular type of tagged item. In one embodiment, the type of item is a precious metal. In one embodiment, the type of item is a vehicle. In one embodiment, the type of item is an electronic device. In these embodiments, the thermally-armored RFID tag preferably works only with a reader of the type for that system. The system preferably also includes a database with at least one piece of information about each specific tagged item, including, but not limited to, ownership, ownership history, physical location of the tagged item, and a description of the tagged item, which may be used to aid in recovery of the tagged item in the event that it is lost or stolen.

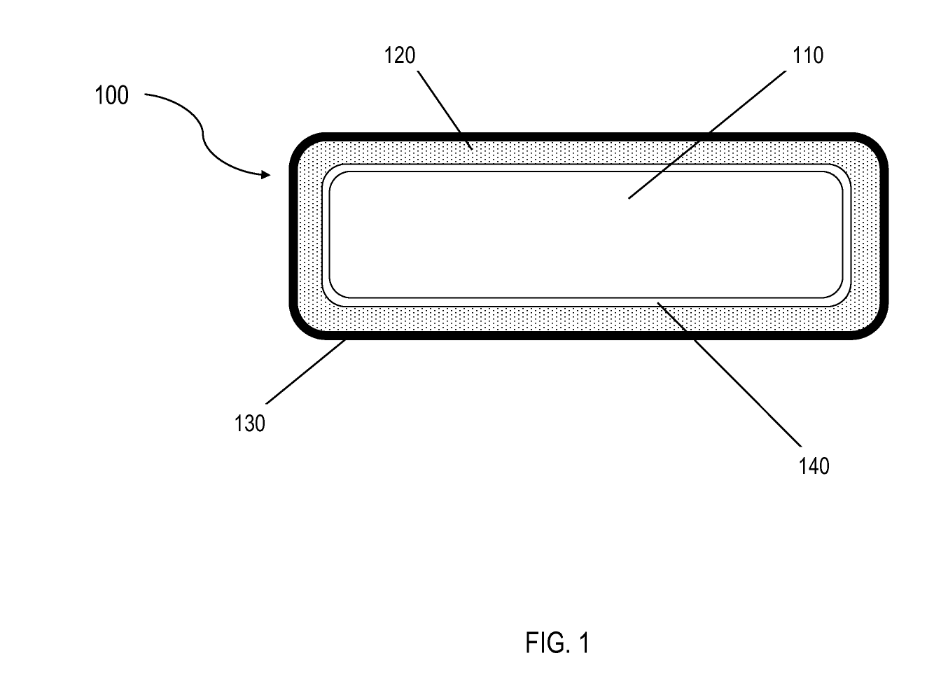

Turning to the figure, FIG. 1 depicts a cross-sectional representation of a thermally-armored RFID tag according to one embodiment of the invention. Thermally-armored RFID tag 100 comprises RFID tag 110; silica glass fibers 120; and a non-heat conductive exterior coating 130. RFID tag 110 is of a size smaller than the inner cavity formed by the silica glass fiber layer 120 such that a space 140 exists between all or part of RFID tag 110 and silica glass fiber layer 120, which permits limited movement of RFID tag 110 within the inner cavity formed by the silica glass layer 120.

In one embodiment, the thermally-armored RFID tag serves as a unique identifier for a vehicle, such as an automobile, truck, motorcycle, bicycle, boat, or airplane. In the case of an automobile, the thermally-armored RFID tag is preferably located somewhere in the chassis and works in conjunction with or in place of the Vehicle Identification Number (VIN, see ISO 3779 and related standards, etc.) for an automobile, truck, motorcycle, or other motorized conveyance. In one embodiment, the thermally-armored RFID tag comprises a high-security RFID tag with an encrypted signal to prevent the jamming or spoofing of the signal with another RFID transmitter emitting a fraudulent VIN signal. The technology employed in this embodiment of the thermally-armored RFID tag makes vehicle theft in which VIN falsification is needed exceedingly difficult.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A thermally protected RFID tag comprising:
an RFID tag; and
a thermally-protective coating sufficient to protect the RFID tag from thermal damage, wherein the thermally-protective coating comprises reinforced carbon-carbon resin, carbon fiber reinforcement in a graphite matrix, polyphenylene ether and olefin resin blend, polyphenylene oxide and polystyrene alloy resin, polyphenylene ether and polypropylene alloy resin or a vinyl ester resin, wherein the vinyl ester resin comprises aromatic ethers and oligoethers having vinyl aromatic and methacrylate end groups that are capable of crosslinking and polycyclization.

2. The thermally protected RFID tag of claim 1, wherein the thermally-protective coating comprises an external non-heat conductive material.

3. The thermally protected RFID tag of claim 2, wherein the thermally-protective coating comprises a first layer comprising silica glass fibers and a second layer adjacent to the first layer comprising modified polyphenylene ether (PPE)/olefin resin blend, polyphenylene oxide and polystyrene alloy resin, polyphenylene ether and polypropylene alloy resin, vinyl ester resin comprising aromatic ethers and oligoethers having vinyl aromatic and methacrylate end groups that are capable of crosslinking and polycyclization, reinforced carbon-carbon (RCC) resin, or carbon fiber reinforcement in a graphite matrix phenolic resin, ceramic enamel, glass enamel, vermiculite enamel, silicate based fiber, cloth resin impregnated

4. The thermally protected RFID tag of claim 2, wherein the RFID tag comprises a battery, wherein the battery comprises at least a partial source of power for the RFID tag circuitry and antenna.

5. The thermally protected RFID tag of claim 4, wherein the RFID tag comprises low-frequency identification, high-frequency identification, or ultra-high frequency identification.

6. The thermally protected RFID tag of claim 2, wherein the thermally-protective coating comprises a non-heat conductive material overlaying a silica glass fiber layer.

7. The thermally protected RFID tag of claim 2, wherein the RFID tag is protected by the thermally protective coating to a temperature of about 200° C.

8. The thermally protected RFID tag of claim 7, wherein the RFID tag is protected by the thermally protective coating to a temperature of about 300° C.

9. The thermally protected RFID tag of claim 8, wherein the RFID tag is protected by the thermally protective coating to a temperature of about 900° C.

10. The thermally protected RFID tag of claim 9, wherein the RFID tag is protected by the thermally protective coating to a temperature of about 1000° C.

11. The thermally protected RFID tag of claim 10, wherein the RFID tag is protected by the thermally protective coating to a temperature of about 1100° C.

12. The thermally protected RFID tag of claim 11, wherein the RFID tag is protected by the thermally protective coating to a temperature of about 1200° C.

13. The thermally protected RFID tag of claim 12, wherein the RFID tag is protected by the thermally protective coating to a temperature of about 1660° C.

14. A method of manufacturing an article having an embedded RFID tag, comprising:
heating a precursor material from which an article of manufacture will be formed to form a molten or semi-molten material;
inserting a thermally-coated RFID tag into the molten or semi-molten precursor material; and
cooling the molten or semi-molten precursor material to form the article of manufacture, wherein the thermally-coated RFID tag comprises:
an RFID tag; and
a thermally-protective coating sufficient to protect the RFID tag from thermal damage, wherein the thermally-protective coating comprises reinforced carbon-carbon (RCC) resin or a vinyl ester resin, wherein the vinyl ester resin comprises aromatic ethers and oligoethers having vinyl aromatic and methacrylate end groups that are capable of crosslinking and polycyclization.

15. The method of claim 14, wherein the precursor material comprises plastic, composite, metal or combinations thereof.

16. The method of claim 15, wherein the article of manufacture comprises a fabricated, molded, cast, or extruded component.

17. The method of claim 16, wherein the article of manufacture comprises a precious metal bar, a precious metal round, a piece of furniture, electronic equipment, a weapon, a component of a weapon, ammunition, medical devices, cargo containers, vehicle components, rail car components, construction materials, or military ordinance.

18. The method of claim 17, wherein the RFID tag is a low-frequency RFID tag, a high-frequency RFID tag, or an ultra-high frequency RFID tag.

19. The method of claim 17, wherein the RFID tag comprises a battery, wherein the battery comprises at least a partial source of power for the RFID tag circuitry and antenna.

20. A method of tracking an article, comprising:
detecting by a radio signal receiver emission of a radio frequency signal from an RFID tag that is representative of a unique identification signal;
interrogating a database, wherein the database comprises a plurality of stored searchable files, wherein each file comprises a unique identification signal, wherein each unique identification signal corresponds to a unique article;
searching the stored files for a unique identification signal that compares favorably to the detected radio frequency signal; and
identifying the unique article corresponding to the unique identification signal that compares favorably to the detected radio frequency signal,
wherein the article is manufactured by the process comprising:
heating a precursor material from which the article will be formed to form a molten or semi-molten material;
inserting a thermally-coated RFID tag into the molten or semi-molten precursor material; and
cooling the molten or semi-molten precursor material to form the article, wherein the thermally-coated RFID tag comprises:
an RFID tag; and
a thermally-protective coating sufficient to protect the RFID tag from thermal damage,
wherein the thermally-protective coating comprises reinforced carbon-carbon (RCC) resin or a vinyl ester resin, wherein the vinyl ester resin comprises aromatic ethers and oligoethers having vinyl aromatic and methacrylate end groups that are capable of crosslinking and polycyclization.

21. The method of claim 20, wherein the article comprises a precious metal bar, a precious metal round, a piece of furniture, electronic equipment, a weapon, a component of a weapon, ammunition, medical devices, cargo containers, vehicle components, rail car components, construction materials, or military ordinance.

22. The method of claim 21, wherein the unique identification signal is encrypted.

23. A method of tracking an article, comprising:
detecting by a radio signal receiver emission of a radio frequency signal from an RFID tag representative of data unique to the article;
wherein the article is manufactured by the process comprising:
heating a precursor material from which the article will be formed to form a molten or semi-molten material;
inserting a thermally-coated RFID tag into the molten or semi-molten precursor material; and
cooling the molten or semi-molten precursor material to form the article, wherein the thermally-coated RFID tag comprises:
an RFID tag; and
a thermally-protective coating sufficient to protect the RFID tag from thermal damage,
wherein the thermally-protective coating comprises reinforced carbon-carbon (RCC) resin or a vinyl ester resin, wherein the vinyl ester resin comprises aromatic ethers and oligoethers having vinyl aromatic and methacrylate end groups that are capable of crosslinking and polycyclization.

24. The method of claim 23, wherein the article comprises a precious metal bar, a precious metal round, a piece of furniture, electronic equipment, a weapon, a component of a weapon, ammunition, medical devices, cargo containers, vehicle components, rail car components, construction materials, or military ordinance.

25. The method of claim 24, wherein the unique identification signal is encrypted.
